(19) United States
(12) Patent Application Publication
(10) Pub. No.: US 2004/0209522 A1
(43) Pub. Date: Oct. 21, 2004

(54) Connector

(76) Inventor: Chih-Kai Chang, Taoyuan Hsien (TW)

Correspondence Address: BIRCH STEWART KOLASCH & BIRCH, PO BOX 747, FALLS CHURCH, VA, 22040-0747, US

(21) Appl. No.: 10/790,134

(22) Filed: Mar. 2, 2004

(30) Foreign Application Priority Data
Apr. 17, 2003 (TW) 092206074

(51) Int. Cl. H01R 12/00

(52) U.S. Cl. 439/676

(57) ABSTRACT

A connector is provided. The connector has an isolation frame and a terminal set. The isolation frame has a receiving space and an adaptor portion apart from said receiving space. The terminal set has a first circuit board, a frame and a second circuit board. The first circuit board is set on one side of the frame. The second circuit board set on another side opposite to said first circuit board such that said first and second circuit boards are positioned parallel to each other with a gap there-between.

### BACKGROUND OF THE INVENTION

1. The Field of the Invention

The present invention relates to a connector, and more particularly relates to a connector capable of preventing bad electrical connection and interferences among the neighboring electronic components having different electrical characteristics in the terminal set of the connector.

2. Description of Related Art

The rapidly developed computer technology has made the desktop computer and notebook computer very popular products, allowing users can link up to the information network to retrieve/transmit information. The feature of using internet for data retrieval/transmission is convenient and borderless, and that is why internet became the one of important resources for personal and office use. And for enjoying these benefits, the computer has to be equipped with connectors for linking on to the internet, and such connectors are mostly RJ45 type. The user usually is required to plug the adaptor into the connector or the telephone line for linking with the internet. However, it is difficult to link up with the internet when the adaptor is damaged, and in order to find out the real time status of the adaptor, some have proposed to install a light-emitting diode on a frontal side of the connector to indicate whether or not the connector is good condition. However, the RJ45 connector commonly produces the high frequency electric wave to affect the other nearby electrical appliances, and the signal of the RJ45 connector can also be affected by the interference from external transmission circuit that could easily cause signal interruption or weaken the signal. Accordingly, some manufacturers have proposed to use a metallic cover case for covering the connector or use a wave-filtering module inside the connector in order to resolve the above defects. The wave-filtering module has a capacitor for protecting the device from a sudden abnormal voltage, and the wave-filtering module is commonly connected to the input/output circuit of the internal circuit.

Referring to FIGS. 6 and 7, an exploded view of a conventional connector and an exploded view of assembly parts of the conventional connector are shown. The conventional connector comprises a terminal set having an adaptor set B and a socket D inlayed into an isolation frame A. The adaptor set B and the socket D of the terminal set have a plurality of terminals B1 and D1 directly welded to the circuit board C. The circuit board C has a wave-filtering module C1 at a rear side thereof. The isolation frame A has two protrusions A1 buckled to the indentations C2 formed at the two side of the circuit board C. Furthermore, an electric magnetic wave proof metallic case E covers the above assembly with the plurality of terminals D1 of the socket D which can be set at a desired position on the circuit board C. Generally, the connector is welded onto the circuit board of the notebook computer by using the surface mounted technology (SMT), however the presently available RJ45 connector with the light-emitting element, capacitor or wave-filtering module can not be welded using the SMT. As shown in FIG. 8, the conventional connector is designed for fitting the terminal set F in the receiving space A2 of the isolation frame A, and a bottom plate F1, which positioned behind the terminal set F is joint to two vertical side plates F2 forms an indented space F3. A plurality of terminals F4 are disposed between the two side plates F2, wherein a primal end of the terminals F4 are jointed to the horizontal circuit board F5 positioned above the terminal set F. Thus a protrusion formed by the electrical component F6 positioned below the circuit board F5 can be received in the indented space F3 of the terminal set F thereby the overall height of the connector (as shown in FIG. 8) can be reduced. But the electronic components in the above conventional connector connecting, the input/output circuit, the wave-filtering module and the capacitor have different electrical characteristics and are connected on a single circuit board, and therefore the interconnection thereon is over dense and therefore easily cause interference among the neighboring electronic components while processing signal transmission. Additionally, voltage-withstanding test for safety is usually performed before the connector is shipped out of the production line, and the voltage used in the test is about 3000 volts. If the gap separating the electronic components in the circuit is too small, the electro magnetic radiations could be produced that could cause short circuit and damage the connector. The height or thickness of the notebook computer is strictly limited to the specification of the circuit board, and accordingly the arrangement of the electric components, the electrical pathways of the circuit is also therefore limited. Thus the space available on the circuit board is accordingly smaller making it difficult to include additional electronic components. Another conventional connector having electronic components with different electrical characteristics connected onto two vertical circuit boards is shown in FIG. 9. Although this design can reduce the signal interference among the electronic components having different electrical characteristics during signal transmission, but still further improvement can be made on this design.

### SUMMARY OF THE INVENTION

Accordingly, in the view of the foregoing, the present invention provides an innovated cost effective a connector capable of preventing bad electrical connection and interferences among the neighboring electronic components having different electrical characteristics in the terminal set of the connector.

According to an aspect of the present invention, a frame of a terminal set is set between a first circuit board and a second circuit board to form a gap there-between so that electrical interference among the neighboring electronic components during signal transmission can be substantially reduced.

According to another aspect of the present invention, the input/output circuit and a wave filter having different electrical characteristics set on the first circuit board and the second circuit board is capable of preventing the electro magnetic radiations could be resulting from a high voltage used during the high voltage-withstanding test to prevent short circuit.

According to another aspect of the present invention, the arrangement and the structure of the assembly parts allow easy assembly and reuse of the assembly parts.

### BRIEF DESCRIPTION OF THE DRAWING

For a more complete understanding of the present invention, reference will now be made to the following detailed description of preferred embodiments taken in conjunction with the following accompanying drawings.

FIG. 1 is an exploded view of a connector according to a preferred embodiment of the present invention.

FIG. 2 is an exploded view of an isolation frame and a terminal set of the connector according to a preferred embodiment of the present invention.

FIG. 3 is an elevational view of isolation frame and the terminal set of the connector according to a preferred embodiment of the present invention.

FIG. 4 is a cross sectional side view showing before assembling the terminal set assembled in the isolation frame according to a preferred embodiment of the present invention.

FIG. 5 is a cross sectional side view showing after assembling the terminal set assembled in the isolation frame according to a preferred embodiment of the present invention.

FIG. 6 is an exploded view of a conventional connector.

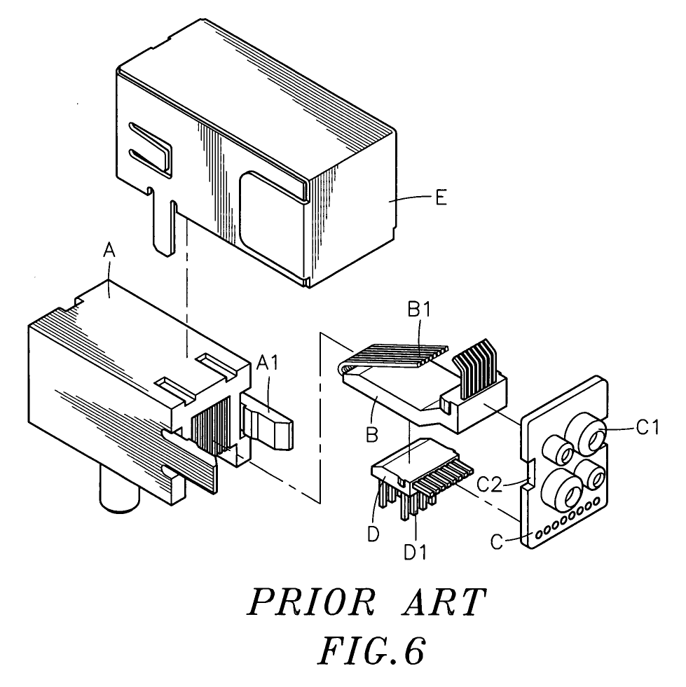

FIG. 7 is an exploded view of the assembly parts of the conventional connector.

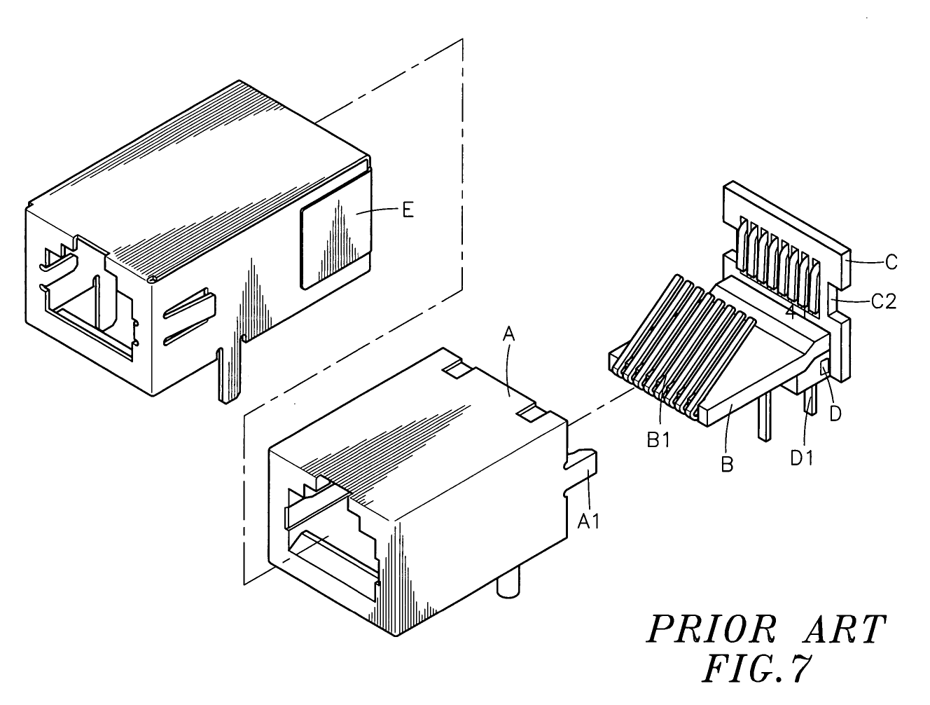

FIG. 8 is an exploded view of another conventional connector.

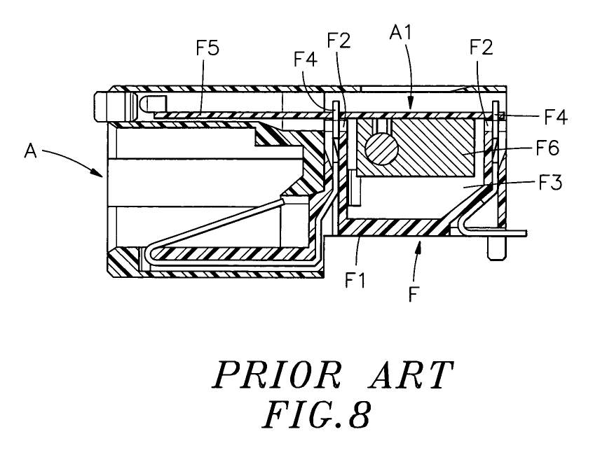

FIG. 9 is a cross sectional side view showing after assembly of the conventional connector.

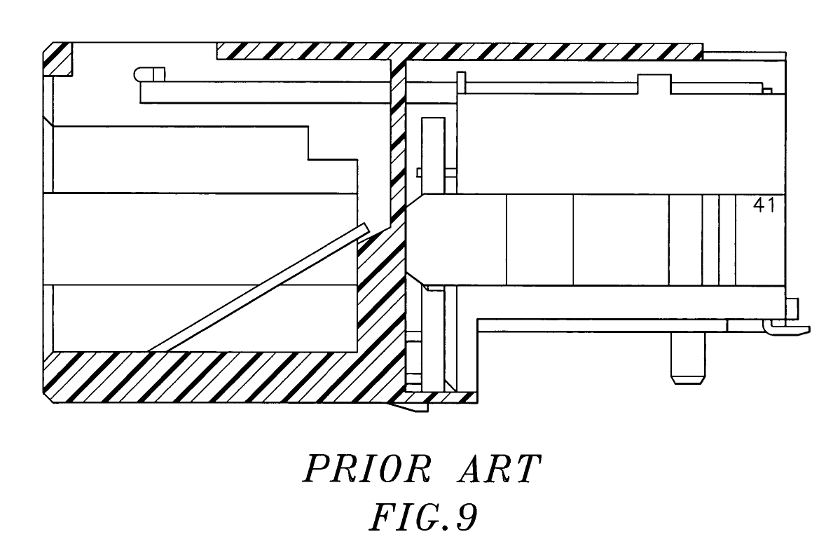

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

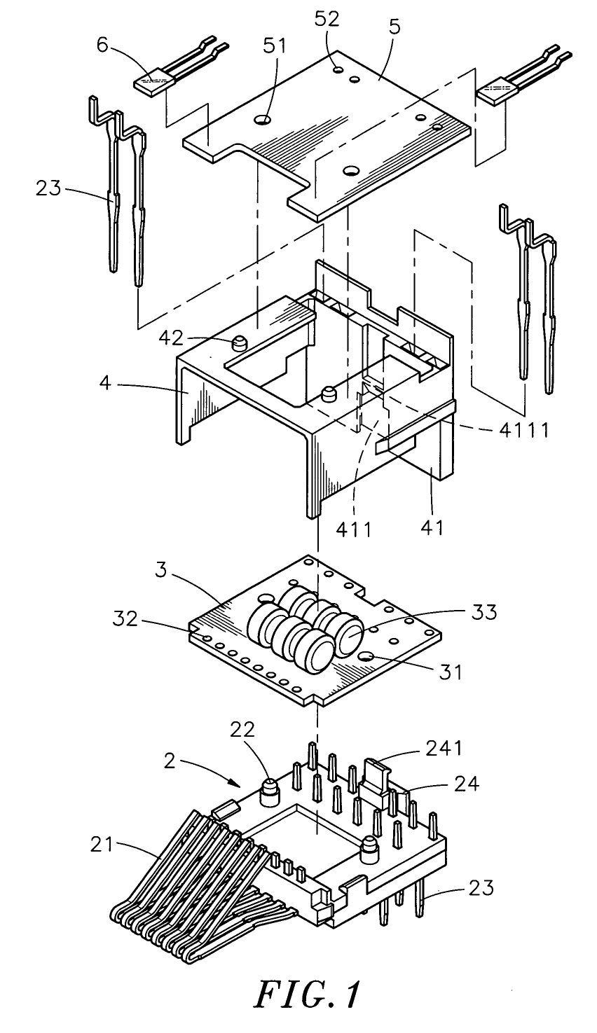

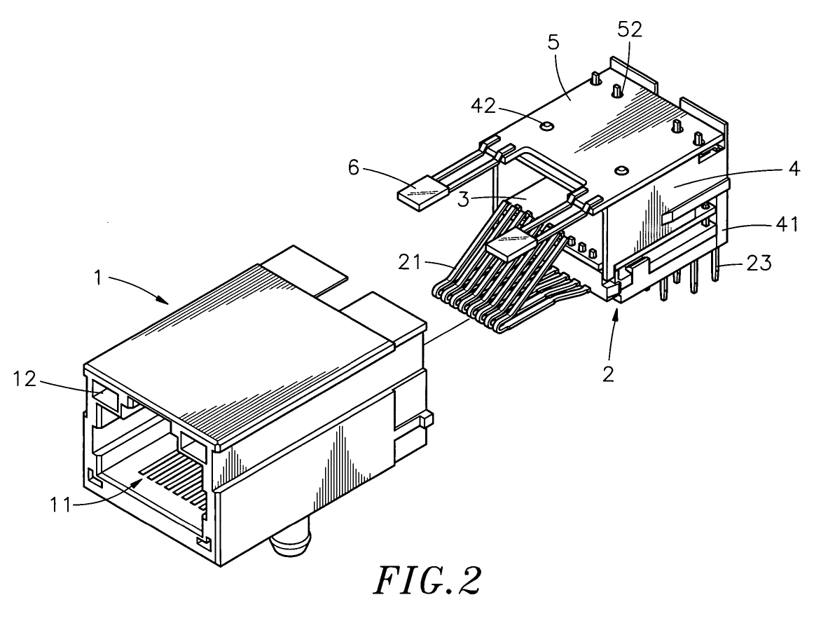

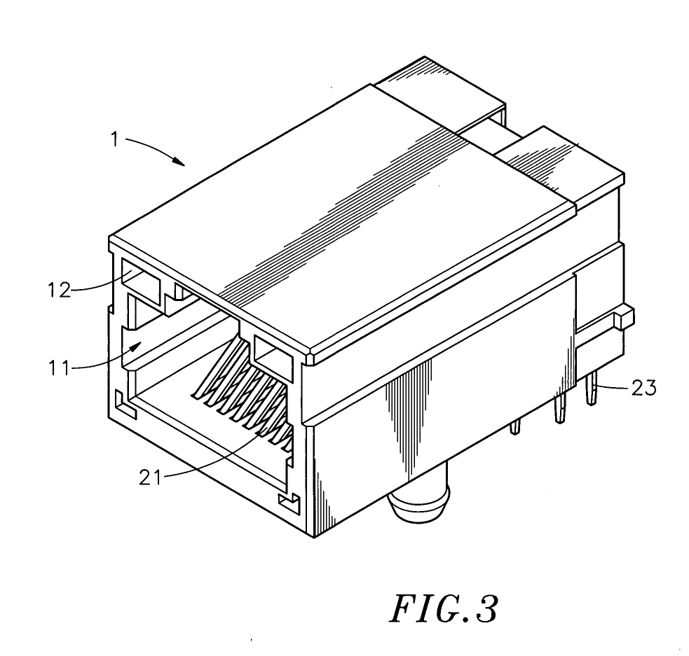

Referring to FIGS. 1, 2 and 3, an exploded view of a connector according to a preferred embodiment of the present invention, an exploded view and an elevational of an isolation frame and a terminal set of the connector according to a preferred embodiment of the present invention are respectively shown. In a preferred embodiment, the connector of the present invention comprises an isolation frame 1 and a terminal set 2.

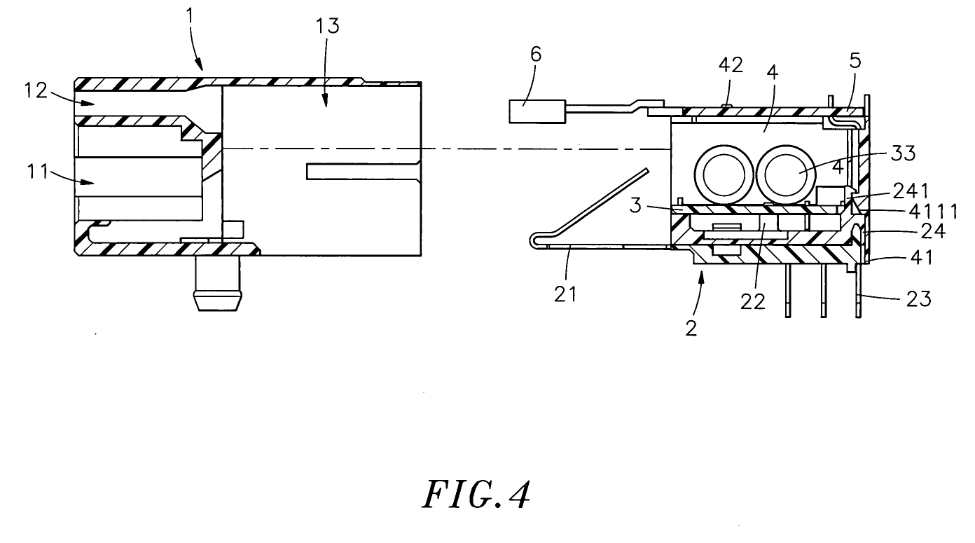

The isolation frame 1 has an adaptor portion 11 formed in a frontal side having two fitting spaces 12 formed respectively at an upper corner of the two sides. The adaptor portion 11 and the fitting spaces 12 are conjoint to the receiving space 13 at the rear portion of the isolation frame 1 (as shown in FIG. 4).

The terminal set 2 has a plurality of adaptor terminal 21 set in a front side, and a plurality of the positioning elements 22 and a plurality of connecting terminals 23 on the surface thereof. The positioning element 22 is for fitting and positioning into the through holes 31 formed on the surface of the first circuit board 3, thus enabling the connecting terminals 23 on the surface of the terminal set 2 to fit into the through hole 32 of the first circuit board 3 where they can be further welded for securely positioning. The first circuit board 3 comprises a plurality of electronic components 33. The terminal set 2 has a protrusion 24 formed extending at a distal end portion thereof. The protrusion 24 has a resilient buckle 241 projecting upward. Furthermore, a frame 4 positioned at an upper side of the first circuit board 3 has, wherein the frame 4 has a fitting portion 41 at a rear side thereof. The fitting portion 41 has a groove 411 having a protruded buckle 4111 such that the protrusion 24 of the terminal set 2 can fit into the groove 411 of the fitting portion 41 of the frame 4. The resilient buckle 241 formed on the surface of the protrusion 24 of the terminal set 2 can be supported on the above buckle 4111 protruding in the groove 411. When resilient buckle 241 is pushed into position, it elastically deforms as it comes against the surface of the buckle 4111 due to the elasticity of the resilient buckle 241, and then the shape of resilient buckle 241 is restored when it is positioned over the buckle 4111 of the groove 411 for secure positioning, and thereby supporting the frame 4 on the surface of the first circuit board 3 and for covering the electric components 33 there-within. Additionally, the frame 4 has a plurality of positioning elements 42 on the surface for fitting into the through holes 51 formed on the surface of the second circuit board 5, and the connecting terminals 23 fitted in the fitting portion 41 of the frame 4 are fitted into the through holes 52 of the second circuit board 5 where they are welded for securely positioning. Additionally, a light-emitting element 6 is welded on the frontal flanges of the two sides of the second circuit board 5.

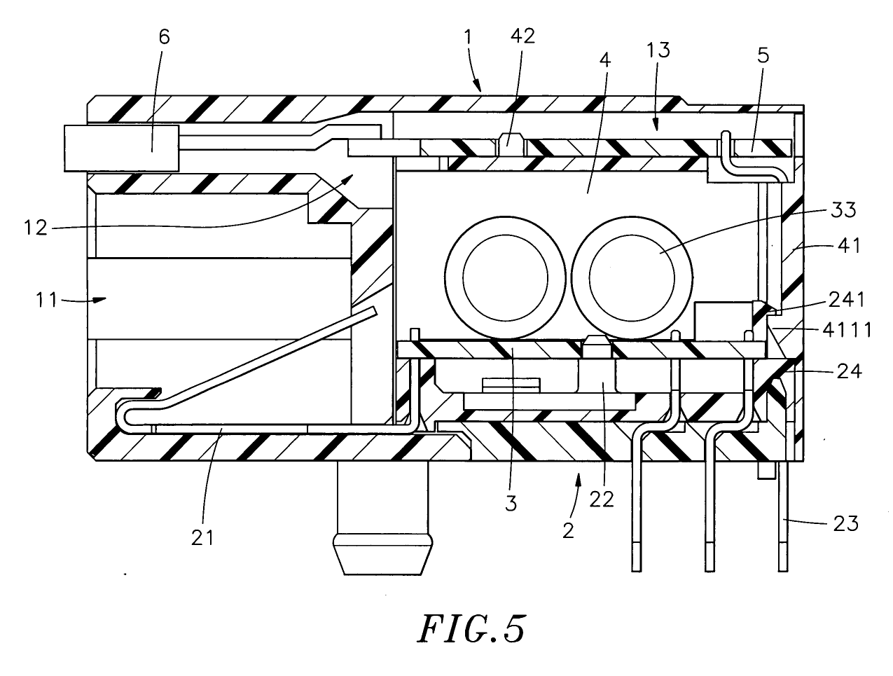

Hereinafter, the assembly of the connector of the present invention will be described with reference to FIGS. 4 and 5. FIGS. 4 and 5 respectively show a cross sectional side views before and after assembling the terminal set assembled in the isolation frame according to a preferred embodiment of the present invention are shown. As shown, the terminal set 2 is fit into the receiving space 13 of the isolation frame 1 such that the plurality of adaptor terminals 21 is positioned in the adaptor portion 11 of the isolation frame 1. The light-emitting element 6 is then welded onto the frontal flanges of the two sides of the second circuit board 5 such that they can fit into the fitting space 12 of the isolation frame 1 so that the light emitted by the light-emitting element 6 can reach to the frontal side of the isolation frame 1.

The connector described above is merely a preferred embodiment of the present invention, the electric component 33 of the first circuit board 3 can also include the capacitor and a wave-filtering module, and the light-emitting element 6 can also be a light-emitting diode.

The connector of the present invention has at least the following advantages compared to the conventional connector described above.

1. The first and second circuit boards 3 and 5 can be positioned parallel and separated by the frame 4 so that the interference between the electronic components formed on the two circuit boards 4 and 5 during the signal transmission can be substantially reduced.

2. The input/output circuit and a wave filter having different electrical characteristics set on the first circuit board 3 and the second circuit board 4 is capable of preventing the electro magnetic radiations could be resulting from a high voltage used during the high voltage-withstanding test to prevent short circuit.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is this invention claimed

1. A connector, comprising:
an isolation frame, having a receiving space and an adaptor portion apart from said receiving space;
a terminal set comprising a first circuit board, a frame and a second circuit board, for inserting into said receiving space of said isolation frame, wherein said first circuit board is set on a surface of said frame, said second circuit board is set on another surface opposite to said first circuit board such that said first and second circuit boards are positioned parallel to each other with a gap there-between.

2. The connector according to claim 1, wherein said first circuit board has a plurality of electronic components thereon.

3. The connector according to claim 2, wherein said first circuit board comprises at least a capacitor.

4. The connector according to claim 2, wherein said first circuit board comprises at least a wave-filtering module.

5. The connector according to claim 1, wherein said terminal set comprises a plurality of positioning elements protruding on a surface thereof, and said first circuit board comprises a plurality of through holes formed on a surface thereof for fitting said positioning elements of said terminal set for positioning.

6. The connector according to claim 1, wherein said terminal set comprises a plurality of connecting terminals for fitting into a plurality of through holes formed on a surface of said first circuit board.

7. The connector according to claim 1, wherein said terminal set comprises a plurality of adaptor terminals set at a frontal side for inserting into the adaptor portion of said isolation frame.

8. The connector according to claim 1, wherein said frame comprises a fitting portion vertically positioned at a backside thereof, and said socket set comprises a groove, and wherein an extended protrusion formed at a distal end of said terminal set is fitted into said groove of said fitting portion for positioning.

9. The connector according to claim 8, wherein said fitting portion of said frame comprises a buckle in said groove, and said protrusion of terminal set comprises a corresponding protruded resilient buckle on a surface thereof, and wherein said resilient buckle buckles onto said buckle in said groove for positioning.

10. The connector according to claim 8, wherein said fitting portion of said frame comprises a plurality of connecting terminals.

11. The connector according to claim 1, wherein said frame comprises a plurality of positioning elements protruding on a surface thereof, and said second circuit board comprises a plurality of through holes formed on a surface thereof, and wherein said positioning elements of said frame fit into said through holes of second circuit board for positioning.

12. The connector according to claim 1, wherein said second circuit board comprises light-emitting elements welded at a frontal flange of two sides thereof, and said isolation frame comprises a fitting space for positioning said light-emitting element.

13. The connector according to claim 12, wherein said light-emitting element comprises a light-emitting diode.

14. The connector according to claim 1, wherein said connector is suitable for connecting with a RJ45 adaptor.

15. The connector according to claim 1, wherein said connector is suitable for connecting with a RJ11 adaptor.
